(19) United States
(12) Patent Application Publication
(10) Pub. No.: US 2012/0078819 A1
(43) Pub. Date: Mar. 29, 2012

(54) METHOD OF STANDARDIZATION OF INJECTALBE MEDICINES AND THEIR DILUENTS

(76) Inventor: Caetano Norival, Sao Paulo (BR)

(21) Appl. No.: 13/058,907

(22) PCT Filed: Aug. 15, 2008
(86) PCT No.: PCT/BR2008/000244

§ 371 Date: Apr. 28, 2011

(51) Int. Cl. G06Q 90/00

(52) U.S. Cl. 705/500

(57) ABSTRACT

“METHOD OF STANDARDIZATION OF INJECTABLE MEDICINES AND THEIR DILUENTS” is particularly intended to eliminate the possibility of confusion arising from the determination of said injectable medicines and their diluents in the general context of health care, such as hospitals, clinics and similar health-related facilities. The method is essentially intended to allow an injectable medicine to be administered following the correct definition of the appropriate diluent required by each product, said method comprising the standardization of a label (1) designed to be attached to vials or containers of injectable medicines, as well as a label (2) specifically designed to be attached to vials or containers of diluents; said label (1) includes information fields for various relevant information that should be corrected in the event of codification.

### TECHNICAL FIELD OF THE INVENTION

The present invention relates to a method of standardization of injectable medicines and their respective diluents, with the aim of eliminating the possibility of confusion arising from the determination of said injectable medicines and their respective diluents in the general context of health care, such as hospitals, clinics and similar health-related facilities.

### PRIOR ART

In Fact Sheet n. 231, October 2006 entitled INJECTION SAFETY, World Health Organization informs that each year at least 16 billion injections are administered only in developing and transitional countries, not including injections administered in developed countries.

Injectable medicines need to be administered in a safe way and for that, the chain of events from manufacturing to effective use must be disciplined. Although this statement may sound patently obvious, the truth is that there is a tremendous confusion in the injection medicine marketplace concerning the absence of a universal standardization, from product nomenclature to labeling, preparation methods, and drug administration.

In this confuse chain of events, and to mention just one reference—American Journal of Health-System Pharmacy Current Issue—Archive Oct. 1, 2001, 58 (19): 1835-1841, in an article entitled “Retrospective analysis of mortalities associated with medication errors”, Jerry Phillips, Associate Director of Food and Drug Administration (FDA), USA, and others, reviewed 5366 medication error reports, of which 469 were fatal. The most common types of errors resulting in patient death involved administering an improper dose (41%), administering the wrong drug (16%), and using the wrong route of administration (9.5%). The most common causes of errors were knowledge deficits (44%) and communication errors (16%). Fatal medication errors accounted for approximately 10% of medication errors reported to FDA..

Medication errors associated with knowledge or communication problems are a serious challenge to be faced. Pharmaceutical Laboratories, Regulation Agencies, Hospitals, and healthcare professionals are all entrapped in an intricate weave of information in which everybody has a hand, and almost always without mastering the specific techniques of this field of action.

Although billions of injectable medicines vials are used annually, the number of drafting, reading, preparation, and administration errors increases on a daily basis. Consequences are easy to understand, since once injected, these products are quickly distributed throughout the body.

We have been working for decades on medicines in general and for five years on injectable medicines as a pharmaceutical company medical director. Based on this work experience, we have concluded that the great problem to be solved by Pharmaceutical Industry is the absence of worldwide standardization of injectable pharmaceutical formulations. Such absence of standardization can be easily observed on product package inserts, packages, labels, and even on pharmaceutical reference texts.

In the 2008 Edition of Drug Facts and Comparisons, there are errors of definition in virtually every antibacterial drug in powder form (which are named FOR INJECTION by United States Pharmacopoeia), wrongly described as INJECTION in the book (which are the products already in the form of solution, according to the United States Pharmacopoeia).

In the 2007 Edition of USP DI (United States Pharmacopoeia—Dispensing Information), there are errors in products like CEFOTETAN FOR INJECTION, on page 775, where there is confusion between reconstitution and dilution in the product preparation guidelines. These terms will be defined hereinafter. This same error appears on several other products in the 2007 Edition of USP DI.

Health Regulatory Agencies on their part require that generic drugs contain a copy of the same information presented by branded products. Therefore, branded products with conceptual errors concerning nomenclature, strength, preparation method, bioequivalence, and stability information spread their errors via generic drugs.

The absence of standardization creates tremendous confusion, which frequently leads to errors in pharmaceutical weighing processes (e.g., when one mistakes ciprofloxacin hydrochloride for ciprofloxacin base), formulation (the same example previously mentioned), analyses (due to nomenclature mistakes), stability profiles (when one mistakes a solution form of a product for a powder form thereof), and, as a consequence, medication dispensing errors (herein understood as errors associated with either the prescription or prescription preparation). On the other hand, there is the same and probably even more confusion in the preparation of injectable products.

All over the world (including developed countries, as previously exemplified), there is confusion between two basic concepts: reconstitution and dilution of injectable products. Typically, reconstituted products (powder mixed to a small volume of diluent, typically Sterile Water for Injection) are less stable than diluted products (products already in a solution form, to which a larger volume of diluent is added to reduce drug concentration). There is also confusion between two methods of drug administration: Direct Injection and Intravenous Infusion (or simply Infusion). The first one is made directly into a vein using a syringe for few minutes or seconds, depending on the product, and the second one is administered using a special bag or container for dripping.

If stability data of a diluted product are considered for a reconstituted product, an error associated with product expiration date would occur, which often leads to a reduced product power. It is nevertheless true that many data published as related to product dilution are actually related to product reconstitution, and vice-versa.

As if all those errors were not enough, numberless errors arise from the use of diluents for injectable medicines each day. Some products only may be reconstituted using Sterile Water for Injection; some others may be reconstituted using Sodium Chloride 0.9%, also. There are products that precipitate in the presence of Sodium Chloride and thus must be reconstituted using only Sterile Water for Injection or Dextrose 5%. There are also products that require a particular diluent, and diluents that are inappropriate for certain age groups (for instance, diluents containing benzyl alcohol should not be used for newborns, because serious neurological disorders and death may occur.)

The scenario discussed above represents the current state of the art concerning the use of injectable medicines on a worldwide scale, and such context suggests that there is an urgent necessity for label standardization, which is provided by the present invention, said standardization including all correlation needed for creating a universal language for injectable products.

Globalization is also a major factor affecting the need for standardization, if one takes into consideration that, nowadays, products rapidly move—through product manufacturing and distribution—across different countries, from different cultures, and different levels of economic development.

Accordingly, it is an object of the present invention to provide a label standardization system for injectable medicines and their diluents, using colors and letters for the most widely used diluents and acronyms only for other diluents that are used comparatively less often.

### BRIEF DESCRIPTION OF THE INVENTION

In view of the background art described above, the present invention, which relates to a method of standardization of injectable medicines and their respective diluents, puts forward the use of a visual code consisting of colors and letters for the most widely used diluents, and of acronyms only for other diluents that are comparatively less often used.

Thus, this visual code enables the creation of markers to be attached to vials of diluents (in the form of a label) and to be reproduced on injectable medicine labels following a standardization, which should be checked by a central organization every time an injectable medicine label is released. The visual code requires product technical concepts to be correct and, therefore, in the event of codification, it is necessary to revise and correct terminological and conceptual errors in injectable products disseminated all over the globe. Immediately, if only reconstitution and dilution errors are correct, millions of human lives and many financial resources of hospitals and health insurance would be saved.

### DESCRIPTION OF THE DRAWINGS

The present invention is described in detail with reference to accompanying drawings listed hereinafter, where:

FIG. 1 illustrates a non-limitative example of an injectable medicine labeling, where the main information fields for the various information that is then standardized are indicated in said label.

FIG. 2 illustrates a non-limitative example of a diluent labeling, where are indicated in said label the main information fields for information that is also a part of the standard presented herein.

FIGS. 3, 3A, 3B, 3C, 3D, 3E, 3F, 3G, 3H, 3I, 3J, and 3K illustrate images of actual examples (including color coding) of labels for a wide range of injectable medicines, being such label layouts according to the standardization presented herein; and

FIGS. 4, 4A, 4B, 4C, 4D, 4E, 4F, 4G, 4H, 4I, 4J, and 4K illustrate images of actual examples (including color coding) of labels for a wide range of diluents, being such label layouts according to the standardization presented herein and in complete conformity with injectable medicine labels showed on FIGS. 4 to 4K.

### DETAILED DESCRIPTION OF THE INVENTION

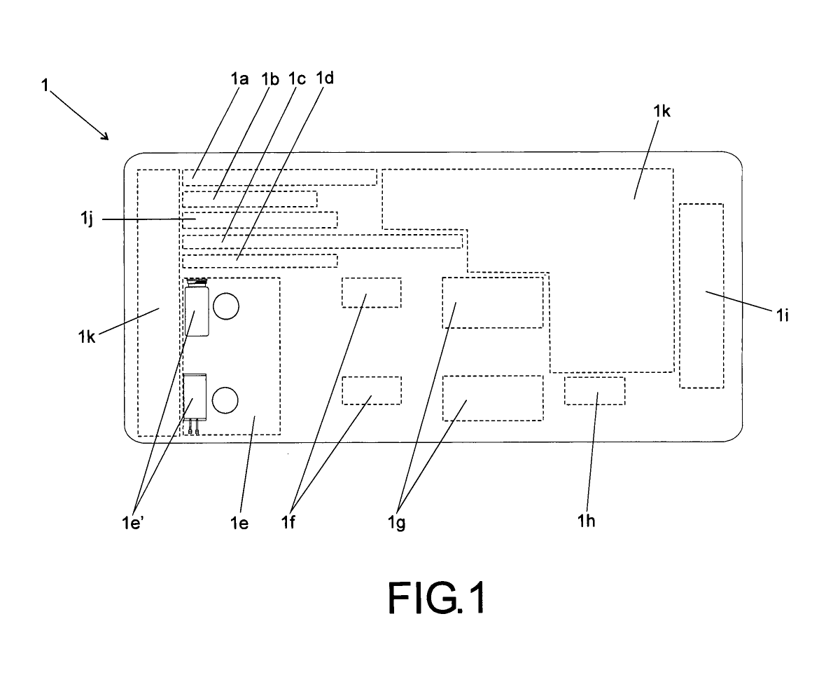

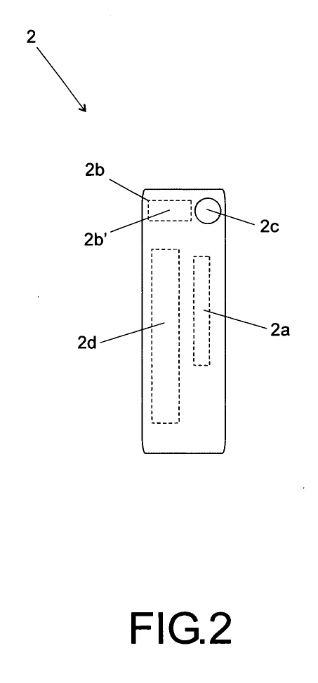

According to the accompanying drawings listed hereinabove, and according specially to FIG. 1 and FIG. 2, it may be noted that the method of standardization presented herein provides labels 1 (FIG. 1) to be attached to injectable medicine vials or containers, as well as labels 2 (FIG. 2) to be specifically attached to diluent vials or containers.

Concerning FIG. 1 specifically, it may be noted that label 1 has basically a rectangular shape, which is to be filled with several information fields.

The information fields above-mentioned comprise: one information field 1a, designed for receiving drug name and concentration (active ingredient/active concentration); one information field 1 b, designed for receiving information on drug physical state/dosage form; one information field 1c, designed for receiving information on the route of administration; one information field 1d, designed for receiving information on preparation method (reconstitution or dilution); one information field 1e, designed for receiving information on type of diluent, said field 1e includes one or more color code allowing direct visual identification of the type or types of diluents that should be used with a particular injectable medicine; with reference to information on drug preparation method, field 1 e presents also a sign or icon 1e′, which visually represents either a vial (where drug is reconstituted) or bag (where drug is diluted) or container where, in both cases, the drug is prepared for injection in the presence of a particular recommended diluent, thus avoiding reconstitution and dilution errors; one or more information fields 1f, designed for receiving information on drug volume, in conformity with information field(s) associated with diluent information; one or more information fields 1g, designed for receiving information on stability/temperature/refrigeration, in conformity with information field(s) associated with diluent and volume information; one information field 1h, with information on duration of administration; one information field 1i, which receives a barcode; one information field 1j, with information on storage conditions; one or more information fields 1k, with other information associated with the drug and drug manufacturer.

FIG. 2 illustrates a non-limitative example of a diluent labeling, where the label itself is indicated by numeric reference 2, as already informed.

Label 2 (FIG. 2) has an essentially rectangular elongated shape including information fields designed for receiving relevant information, where: information field 2a contains information on the type of diluent; information field 2b, in which an easily visible acronym 2b′ is printed, indicating the written form of the type (name) of diluent; information field 2c, in which a color code is printed; and information field 2d, in which a barcode is printed.

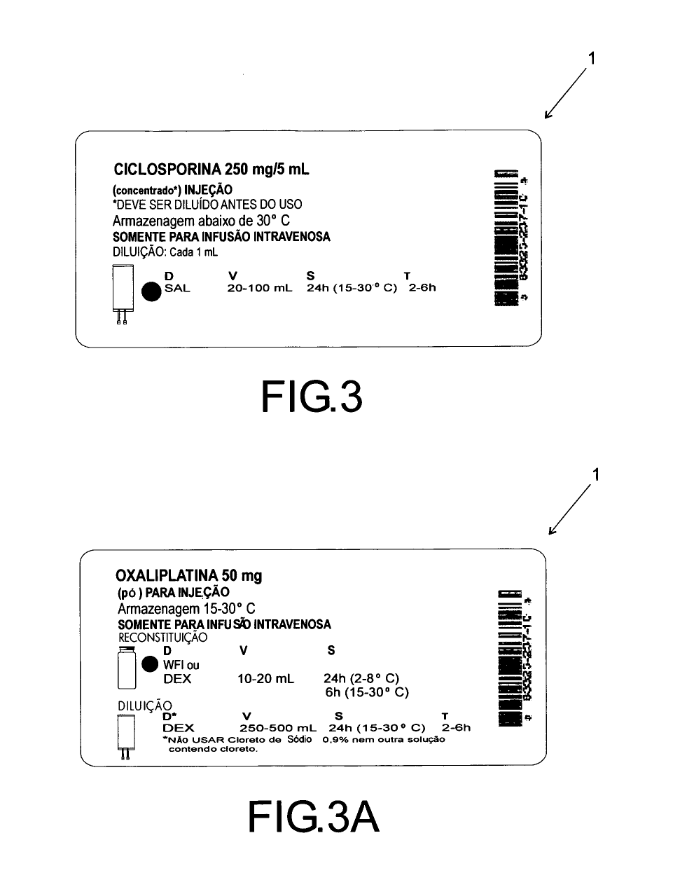

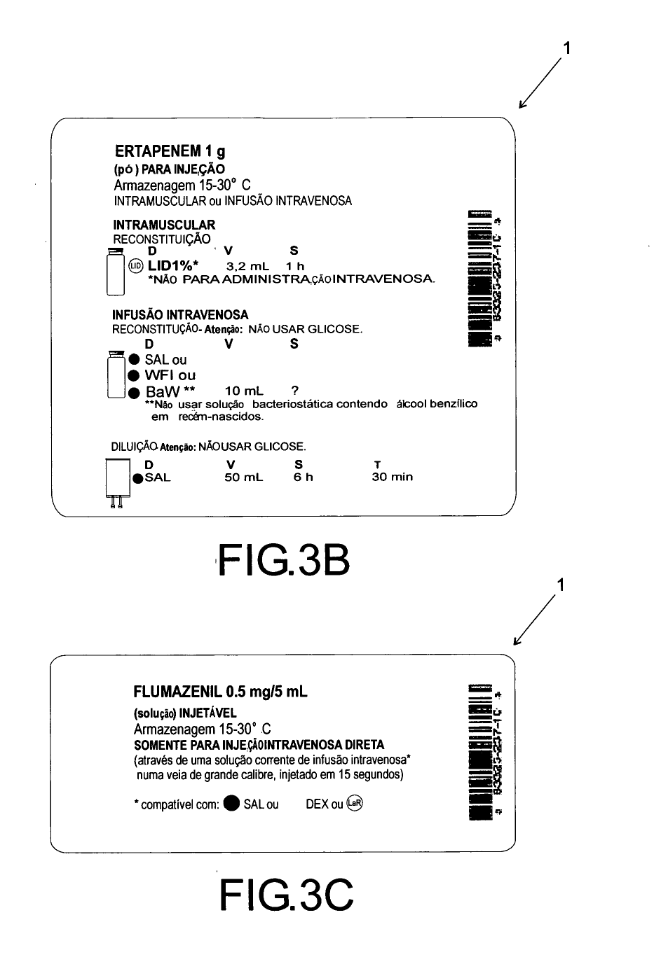

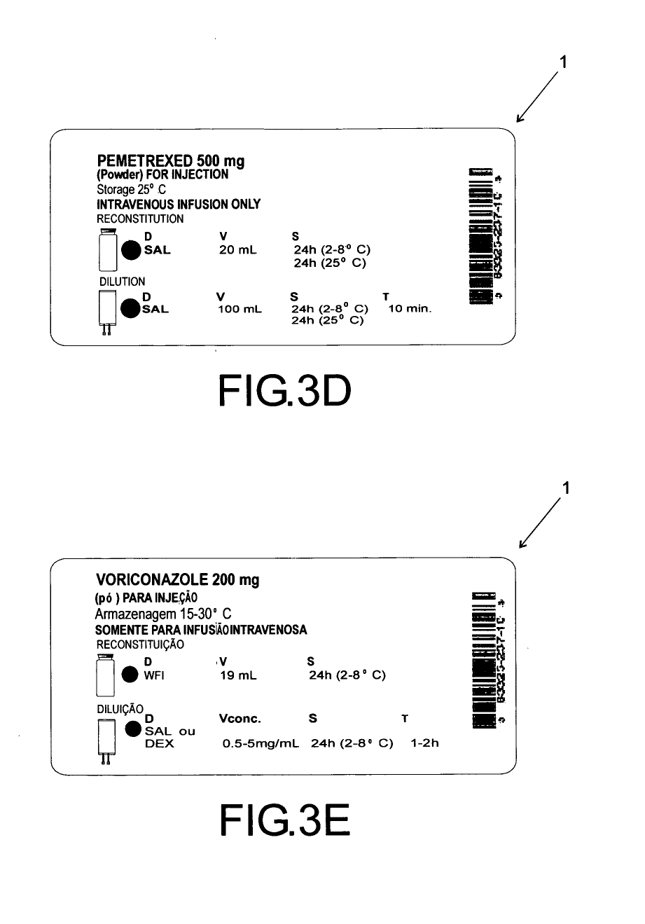

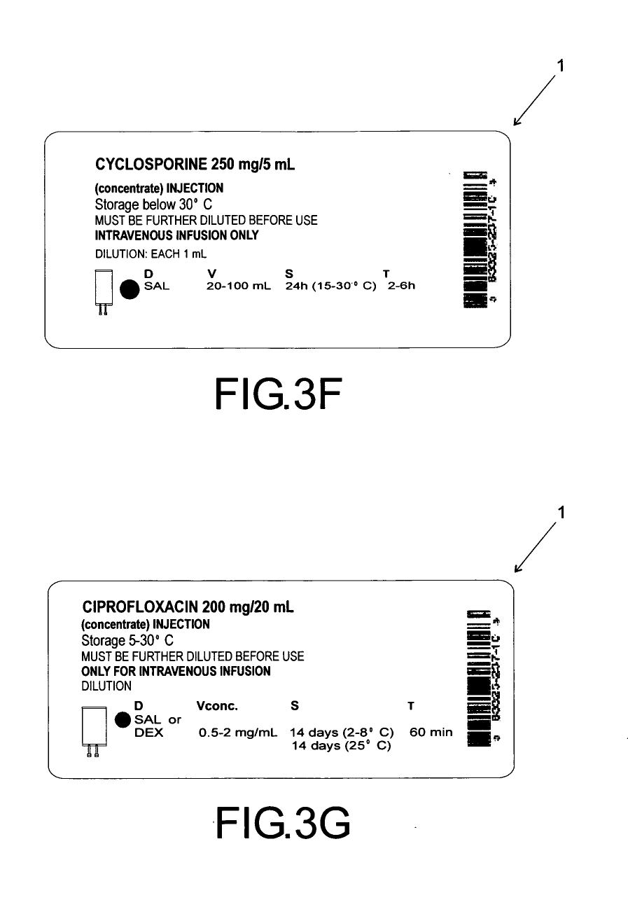

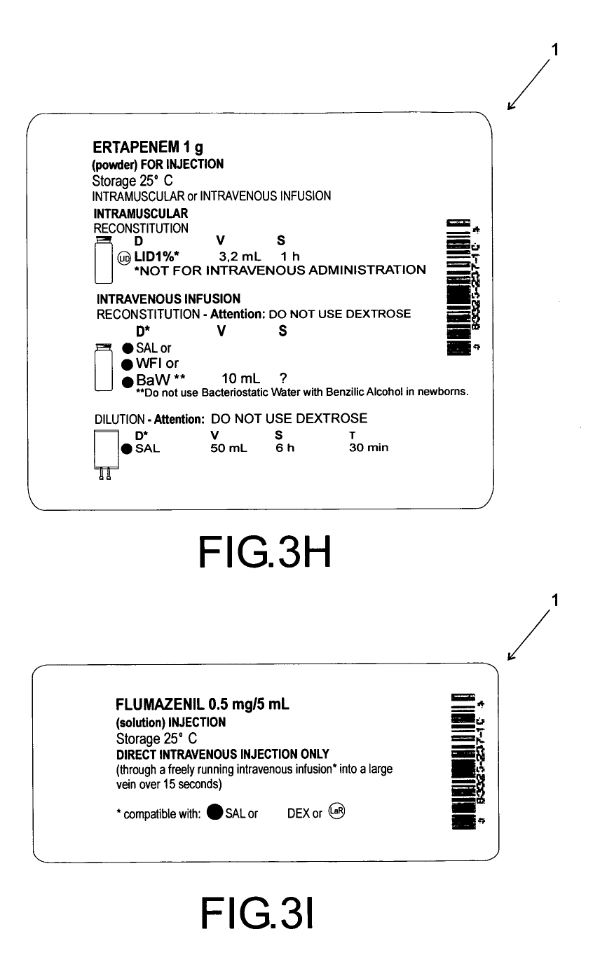

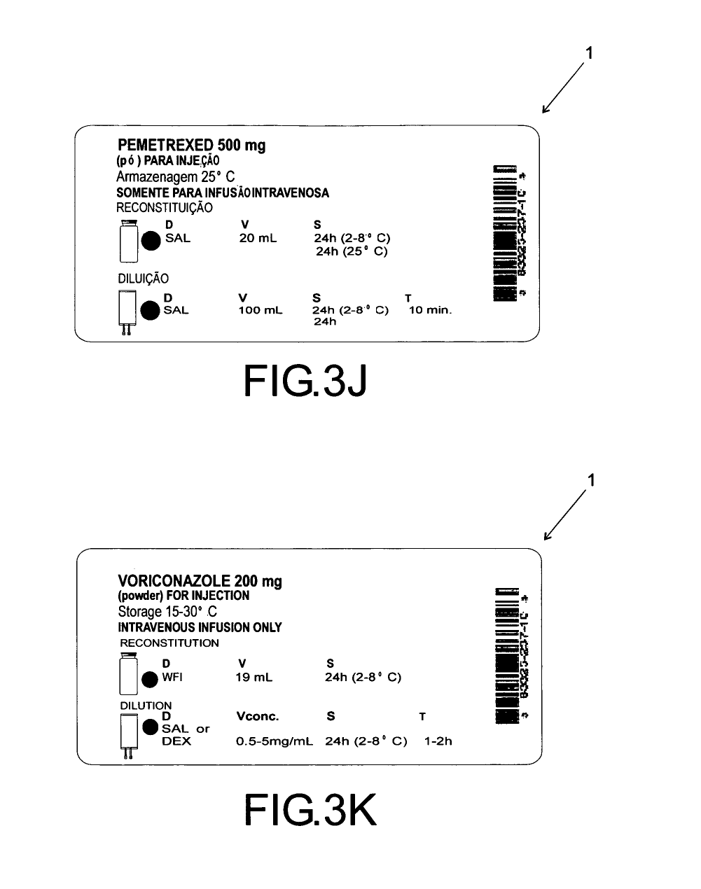

FIGS. 3, 3A, 3B, 3C, 3D, 3E, 3F, 3G, 3H, 3I, 3J, and 3K illustrate images of actual examples (including color coding) of labels 1 for a wide range of injectable medicines, being such label layouts according to the standardization presented herein and, checked against FIG. 1, it may noted in practice the easy identification and the orderly layout of information content, which are crucial for a correct drug preparation and administration.

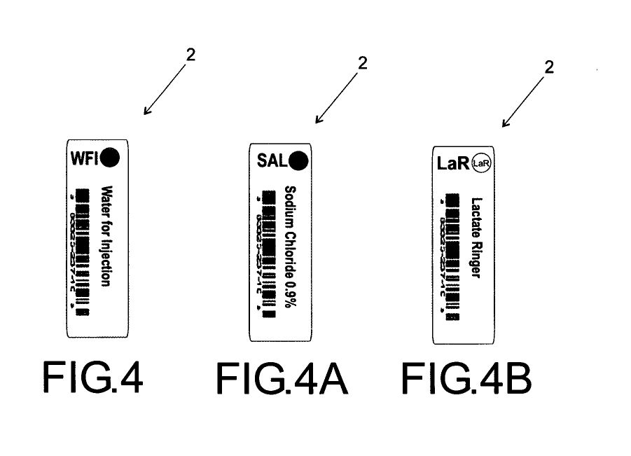

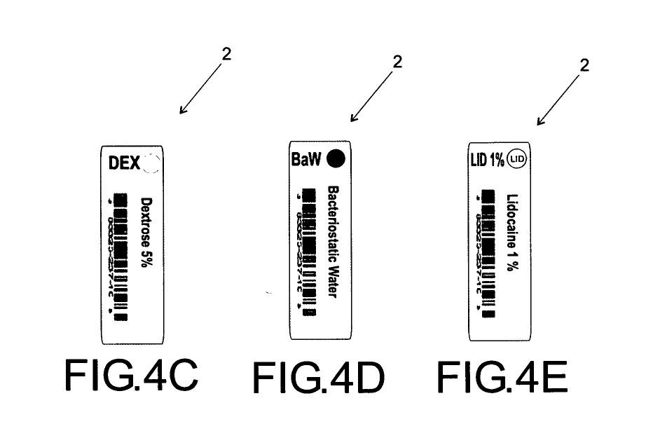

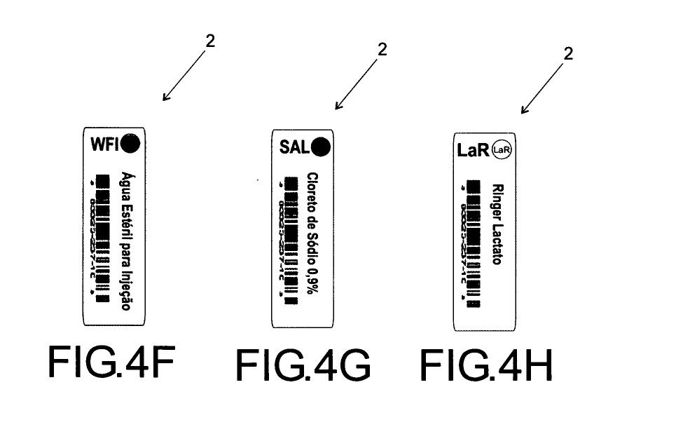

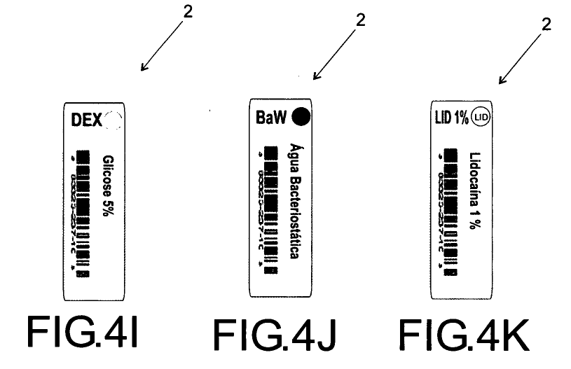

Labels of FIGS. 3, 3A, 3B, 3C, 3D, 3E, 3F, 3G, 3H, 3I, 3J, and 3K were produced in conformity with labels 2 for diluents, such as those presented as examples on FIGS. 4, 4A, 4B, 4C, 4D, 4E, 4F, 4G, 4H, 4I, 4J, and 4K.

FIGS. 4, 4A, 4B, 4C, 4D, 4E, 4F, 4G, 4H, 4I, 4J, and 4K above-mentioned illustrate images of actual examples (including color coding) of labels for a wide range of diluents, being such label layouts according to the standardization presented herein and in complete conformity with injectable medicine labels showed on FIGS. 3 to 3K, which makes easier to know immediately all relevant information concerning the injectable medicine, including the type of required diluent, while handling the product.

Labels 2 for diluent containers, on their part, bring basic information that allow an easy, direct correspondence with the labels of injectable medicines, which may be used in combination with a given diluent.

The color code presented as an example in the accompanying drawings herein reproduced was standardized as follows: a) blue—Water for Injection, H2O, acronym: “WFI”; b) red—Saline 0.9%, NaCl 0.9%, acronym: “SAL”; c) yellow—Dextrose 5%, Dextrose 5%, acronym: “DEX”; d) black—Potassium Chloride, KCl, acronym: “POT”; e) green—Bacteriostatic Water, acronym: “BaW”.

The present standardization also plans acronyms for diluents, as in the example: a) “Lar”—Lactated Ringer's Injection; and b) “LID”—Lidocaine.

Figures presented above contain a few examples of coded injectable medicines and their respective diluent, and it is possible to claim that the method of standardization presented herein is completely reproducible for virtually every injectable product known in the world.

In the examples that appear in the present invention, the method of standardization presented herein was already used with the aim of correcting some distortions found by the applicant in technical information associated with injectable products (nomenclature, concentration, storage, and stability data).

It should be remarked that the codification (standardization) was made possible only after the elucidation of technical concepts, which are to be faithfully reproduced on product package, label, and package insert, in fact on every communication opportunity, following codification review.

### Legenda—FIG. 3

| | |
|---|---|
| CICLOSPORINA 250 mg/5 mL | CYCLOSPORINE 250 mg/5 mL |
| (concentrado*) INJE [symbol] ÃO | (concentrate) INJECTION |
| * DEVE SER DILUÍDO | * MUST BE FURTHER DILUTED |
| ANTES DO USO | BEFORE USE |
| Armazenagem abaixo de 30° C. | Storage below 30° C. |
| SOMENTE PARA INFUSÃO | INTRAVENOUS INFUSION ONLY |
| INTRAVENOSA | |
| DILUI [symbol] ÃO: Cada 1 mL | DILUTION: Each 1 mL |

### Legenda—FIG. 3A

| | |
|---|---|
| OXALIPLATINA 50 mg | OXALIPLATIN 50 mg |
| (pó) PARA INJE [symbol] ÃO | (powder) FOR INJECTION |
| Armazenagem 15-30° C. | Storage 15-30° C. |
| SOMENTE PARA INFUSÃO | INTRAVENOUS INFUSION |
| INTRAVENOSA | ONLY |
| RECONSTITUI [symbol] ÃO | RECONSTITUTION |
| DILUI [symbol] ÃO | DILUTION |
| * NÃO USAR Cloreto de Sódio 0.9% | * DO NOT USE Sodium Chloride |
| nem outra solução contendo cloreto. | 0.9% or any other Chloride Solution. |

### Legenda—FIG. 3B

| | |
|---|---|
| ERTAPENEM 1 g | ERTAPENEM 1 g |
| (pó) PARA INJE [symbol] ÃO | (powder) FOR INJECTION |
| Armazenagem 15-30° C. | Storage 15-30° C. |
| INTRAMUSCULAR ou INFUSÃO | INTRAMUSCULAR INJECTION |
| INTRAVENOSA | or INTRAVENOUS INFUSION |
| INTRAMUSCULAR | INTRAMUSCULAR |
| RECONSTITUI [symbol] ÃO | RECONSTITUTION |
| * NÃO PARA ADMINISTRA [symbol] ÃO | * NOT FOR INTRAVENOUS |
| INTRAVENOSA. | ADMINISTRATION |
| INFUSÃO INTRAVENOSA | INTRAVENOUS INFUSION |
| RECONSTITUI [symbol] ÃO-Atenção: | RECONSTITUTION-Attention: |
| NÃO USAR GLICOSE | DO NOT USE DEXTROSE. |
| SAL ou WFI ou BaW | SAL or WFI or BaW |
| ** Não usar solução bacteriostática | ** Do not use Bacteriostatic Water |
| contendo álcool benzílico em recém- | with Benzyl Alcohol for newborns. |
| nascidos. | |
| DILUI [symbol] ÃO-Atenção: NÃO USAR | DILUTION-Attention: DO NOT |
| GLICOSE. | USE DEXTROSE. |

### Legenda—FIG. 3C

| | |
|---|---|
| FLUMAZENIL 0.5 mg/5 mL | FLUMAZENIL 0.5 mg/5 mL |
| (solução) INJETÁVEL | (solution) INJECTION |
| Armazenagem 15-30° C. | Storage 15-30° C. |
| SOMENTE PARA INJE [symbol] ÃO | DIRECT INTRAVENOUS |
| INTRAVENOSA | INJECTION |
| DIRETA | ONLY |
| (através de uma solução corrente | (through a freely running |
| de infusão intravenosa* numa veia | intravenous infusion* into a |
| de grande calibre, injetado em 15 | large vein for 15 seconds) |
| segundos) | |
| * compatível com SAL ou DEX ou | * compatible with SAL or DEX or |

### Legenda—FIG. 3E

| | |
|---|---|
| VORICONAZOLE 200 mg | VORICONAZOLE 200 mg |
| (pó) PARA INJE [symbol] ÃO | (powder) INJECTION |
| Armazenagem 15-30° C. | Storage 15-30° C. |
| SOMENTE PARA INFUSÃO | INTRAVENOUS INFUSION |
| INTRAVENOSA | ONLY |
| RECONSTITUI [symbol] ÃO | RECONSTITUTION |
| DILUI [symbol] ÃO | DILUTION |

### Legenda—FIG. 3J

| | |
|---|---|
| PEMETREXED 500 mg | PEMETREXED 500 mg |
| (pó) PARA INJE [symbol] ÃO | (powder) INJECTION |
| Armazenagem 25° C. | Storage 25° C. |
| SOMENTE PARA INFUSÃO | INTRAVENOUS INFUSION |
| INTRAVENOSA | ONLY |
| RECONSTITUI [symbol] ÃO | RECONSTITUTION |
| DILUI [symbol] ÃO | DILUTION |

1. A method of standardization of injectable medicines and their diluents, wherein said standardization is intended to allow an injectable medicine to be administered following the correct definition of the appropriate diluent required by each product, said method comprising the standardization of a label, which is designed to be attached to vials or containers of injectable medicines, as well as a label, which is specifically designed to be attached to vials or containers of diluents; said label includes information fields for various relevant information, wherein there is provision for one information field, which is designed for receiving drug name and concentration (active ingredient/active concentration); one information field designed for receiving information on drug physical state/dosage form; one information field, designed for receiving information on the route of administration; one information field, designed for receiving information on preparation method; one information field, designed for receiving information on type of diluent, said field includes one or more color code allowing direct visual identification of the type or types of diluents that should be used with a particular injectable medicine; one or more information fields, designed for receiving information on drug volume, in conformity with information field(s) associated with diluent information; one or more information fields, designed for receiving information on stability/temperature/refrigeration, also in conformity with information field(s) associated with diluent and volume information; one information field, with information on duration of administration; one information field, which receives a barcode; one information field RODE with information on storage conditions; one or more information fields, designed for receiving information associated with drug identification and drug manufacturer; with reference to information on drug preparation method, said field presents also a sign or icon, which visually represents either a vial (where injectable medicine is reconstituted) or bag (where injectable medicine is diluted) or container where, in both cases, drug is prepared for injection in the presence of a particular recommended diluent; label has an essentially rectangular elongated shape including information fields designed for receiving relevant information, where: information field receives information on the type of diluent; information field, in which an acronym indicating the written form of the type of diluent or diluent name is printed; information field, in which a color code is printed; and information field, which receives a barcode.

2. The method accordingly to claim 1, wherein said method of standardization allows that all relevant information concerning the product, including the type of required diluent, be immediately known when the injectable medicine container comprising said label is handled.

3. The method accordingly to claim 1, wherein said labels (2) designed for diluent containers bring basic information that allow an easy, direct correspondence with the labels (1) of injectable medicines that may be used in combination with a given diluent.

4. The method accordingly to claims 1, 2, or 3, wherein said method of standardization provides a color code associating an injectable drug with a respective diluent.

5. The method accordingly to claims 1 or 3, wherein said color code attached to labels (1) and (2) is standardized as exemplified:
a) blue—Sterile Water for Injection, H2O, acronym: “WFI”; b) red—Saline 0.9%, NaCl 0.9%, acronym: “SAL”; c) yellow—Dextrose 5%, Dextrose 5%, acronym: “DEX”; d) black—Potassium Chloride, KCl, acronym: “POT”; e) green—Bacteriostatic Water for Injection, acronym: “BaW”.

6. The method accordingly to claims 1, or 3, wherein said standardization also plans acronyms for diluents, as exemplified: a) “Lar”—Lactated Ringer's Injection; and b) “LID”—Lidocaine.

7. The method accordingly to claim 1, wherein the information comprised in said label (1), specially concerning the color code and other relevant information on diluents, corresponds with the color code used in said label (2).
